(19) United States
(12) Patent Application Publication
(10) Pub. No.: US 2004/0183673 A1
(43) Pub. Date: Sep. 23, 2004

(54) Portable detachable self-contained tracking unit for two-way satellite communication with a central server

(76) Inventor: Hans Peter Nageli, Baar (CH)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/768,548

(22) Filed: Jan. 30, 2004

Related U.S. Application Data
(60) Provisional application No. 60/444,029, filed on Jan. 31, 2003.

(51) Int. Cl. G08B 1/08

(52) U.S. Cl. 340/539.13; 340/825.49

(57) ABSTRACT

A portable detachable tracking unit for shipping containers which provides communication via satellite with a central server is provided. The tracking unit has an antenna to communicate both with the GPS satellite and a two-way satellite, a computer, a GPS receiver, a satellite transmitter, a modem and an internal power source. The tracking unit can be attached and detached from the shipping container and is can be attached to the locking bars on the doors of the shipping container. The tracking unit may have sensors for determining when it has been tampered with or detached from the shipping container and transmitting that information to the central server. The tracking unit may have a memory capable of receiving and storing geo-fencing information on the specific route to be taken to the destination with the computer being programmed to determine if the tracking unit is outside of the geo-fence or not and communicating that information to the central server. The tracking unit may have a sensor to determine whether it has been detached from a door of the shipping container and transmitting that information to the central server. A built-in tracking unit is also provided which can communicate whether a door of the shipping container has been opened or not from information supplied by a sensor.

### CROSS-REFERENCE TO RELATED APPLICATION

This application claims priority to copending U.S. provisional application no. 60/444,029 entitled, Portable Detachable Self-Contained Tracking Unit For Two-Way Satellite Communication With A Central Server, filed Jan. 31, 2003, which is entirely incorporated herein by reference.

### FIELD OF THE INVENTION

The invention relates generally to tracking systems, and more particularly, to a method and apparatus for tracking containers along the surface of the earth and monitoring the security of the containers.

### BACKGROUND OF THE INVENTION

With the development of global positioning system (GPS) satellites, there have been many products that have been developed such as navigation systems in automobiles and tracking systems for locating various items such as freight containers and automobiles. The GPS utilizes multiple satellites orbiting the earth. The GPS satellites are programmed to synchronize transmitted signals to the surface of the earth. In other words, the GPS satellites are programmed to transmit signals at the same time to the surface of the earth. In this regard, a GPS receiver receives the transmitted signal from the GPS satellites and calculates the amount of time that the transmitted signal is received. This allows the GPS receiver to estimate its distance to the GPS satellites and calculate the receiver's position along the surface of the earth.

Baker, U.S. Pat. No. 6,339,397, discloses a GPS tracking system that includes a portable self-contained tracking unit. The tracking unit utilizes GPS satellites orbiting the earth to determine its location along the surface of the earth.

The Baker tracking unit includes a cellular telephone as a transmitter. The cellular transmitter transmits its signal to a cellular service provider, which in turn sends the data over the Internet to a database on a central server computer. Customers may access the data from the central server computer via a web page on the Internet.

Orbcomm Global, LP, has developed a two-way satellite communication system. The Orbcomm system includes multiple satellites and multiple ground base stations (“gateway”). The ground base stations transmit signals that control the satellites, and receive signals from the satellites to monitor the activities of the satellites. The satellites are programmed to receive signals from a “subscriber communicator” that transmits signals to the satellites, in which the satellites relays the signals to the ground base stations. A “subscriber computing device” is connected to the gateway via a network. The subscriber communicator and subscriber computing device may communicate to one another via the two-way satellite communication system provided by Orbcomm.

In this regard, there is a need in the industry to utilize the Orbcomm two-way satellite communication system and the global positioning satellite system to track containers along the surface of the earth.

Further, containers for housing transporting items, such as food product, merchandise, etc., are becoming very inexpensive compared to the cost of transporting the containers with transporting items and the cost of bringing the containers back to its original location, particularly in the train, truck and ship industry. Containers are typically discarded after two (2) or three (3) trips of transporting items. In this regard, a tracking device can not be permanently installed on the container. Therefore, there is need in the industry to provide a tracking device that is portable, detachable, self-contained, and easily installed on the containers. Further, there is a need in the industry for a tracking system that includes the portable, detachable, and self-contained tracking device, the tracking device utilizes the GPS satellites and the Orbcomm two way satellite communication system. Further, there is a need for a central server that provides access to one or more users the tracking information provided by the portable, detachable, self-contained tracking device.

### SUMMARY

This invention relates to a system for tracking the location of shipping containers, such as those shipped by sea or on trains or trailers pulled by trucks. A portable detachable tracking unit is attached to the shipping container. This unit has an antenna that is capable of communicating with both a GPS satellite and a two-way satellite. The tracking unit also has a computer, a GPS receiver, a satellite transmitter, and a modem. An internal power supply such as a battery or fuel cell is provided. This tracking unit can be easily attached and detached from the shipping container. This permits the tracking unit to be transferred from one container to another container. The tracking unit can have means for detecting when it has been detached from the shipping container. A simple spring in the back of the unit which establishes contact with the shipping container can be used. If the tracking unit is removed by unauthorized personnel, the spring will extend and make electrical contact and send a signal to the computer which will generate a message to be sent via the satellite to the central server. Sensors can also be provided in the tracking unit to determine when the tracking unit has been tampered with and to send a similar signal to the central server.

The tracking unit can have a receiver for receiving commands or queries from the central server. The tracking unit can have a memory that is capable of receiving and storing geo-fencing information on the specified route the shipping container is to take to the destination with the computer being programmed to determine if the tracking unit is outside of the geo-fence and to communicate that information to the central server. The tracking unit has an internal power supply which may be a battery or fuel cell or a fuel cell and a battery.

The portable detachable unit can be mounted on one of the doors of the shipping container and locked with the locking bar that these containers have for locking the door. The tracking unit can be locked to the locking bar so that the locking bar cannot be unlocked without detaching the tracking unit first. The locking bar on these containers can move up out of a locked position to allow the doors to be opened. The tracking unit can be clamped onto the locking bar and secured to the door so that the locking bar cannot be moved up without detaching the tracking unit. Special fasteners, such as special studs, that require a special tool to open can be used to provide an additional measure of security for the tracking unit.

Preferably, the antenna is vertical in relation to the earth to improve reception. The antenna is capable of receiving GPS and transmitting and receiving VHS communications.

A built-in tracking unit can be provided that serves all the functions described above that determines by a sensor when the door of the shipping container is opened and communicates that to a satellite. It can also determine whether the tracking unit has been tampered with and communicate that information to the central server.

The tracking unit of this invention may have a power management and control circuit for regulating the power consumption so that part of the electronics of the unit can periodically be placed in the sleep mode to conserve power.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic view of an embodiment of a system for tracking a container via two-way satellite communication.

FIG. 2 is a schematic view of an embodiment of a portable, detachable and self-contained tracking unit and a local interface device.

FIG. 3 is a block diagram of an embodiment of the portable, detachable, and self-contained tracking unit as shown in FIG. 1.

FIG. 4 is a block diagram of an embodiment of a user central server as shown in FIG. 1.

FIG. 5 is a perspective view of an embodiment of the portable, detachable, and self-contained tracking unit as shown in FIG. 1.

FIG. 6 is a flow diagram that illustrates an embodiment of operation of the system shown in FIG. 1 for tracking containers.

FIG. 7 is a flow diagram that illustrates an embodiment of operation of the user central server shown in FIG. 1.

FIG. 8 is a flow diagram that illustrates an embodiment of operation of the portable, detachable, and self-contained tracking unit shown in FIG. 1.

FIG. 9 is a perspective view of a belt for securing the tracking unit to the locking rods for locking the doors of a shipping container or the doors for the trailer portion of a tractor-trailer.

FIG. 10 is a perspective view of a locking mechanism for securing the tracking unit to the doors of the shipping container or the doors of the trailer portion of a tractor-trailer.

FIG. 11 is a perspective view of a stud for locking the brackets shown in FIG. 10.

FIG. 12 is a perspective view of a system for securing the tracking unit through the locking rods for locking the doors of a shipping container or the doors for the trailer portion of a tractor-trailer.

FIG. 13 is a cross-sectional view taken along line 13-13 in FIG. 12.

FIG. 14 is an exploded view of the tracking unit showing the rear of the box and a bracket exploded away phantom lines of a locking bar within the bracket.

FIG. 15 is a perspective view showing the tracking unit being attached to a single locking rod on the door of a shipping container or trailer.

### DETAILED DESCRIPTION OF THE DRAWINGS

Disclosed herein are systems and methods for tracking containers. In particular, the container can be tracked via a GPS system and two-way satellite communication network. Example systems are first discussed with reference to the figures. Although the systems are described in detail, they are provided for purposes of illustration only and various modifications are feasible. After the example systems have been described, examples of operation of the systems are provided to explain the manner in which the container can be tracked.

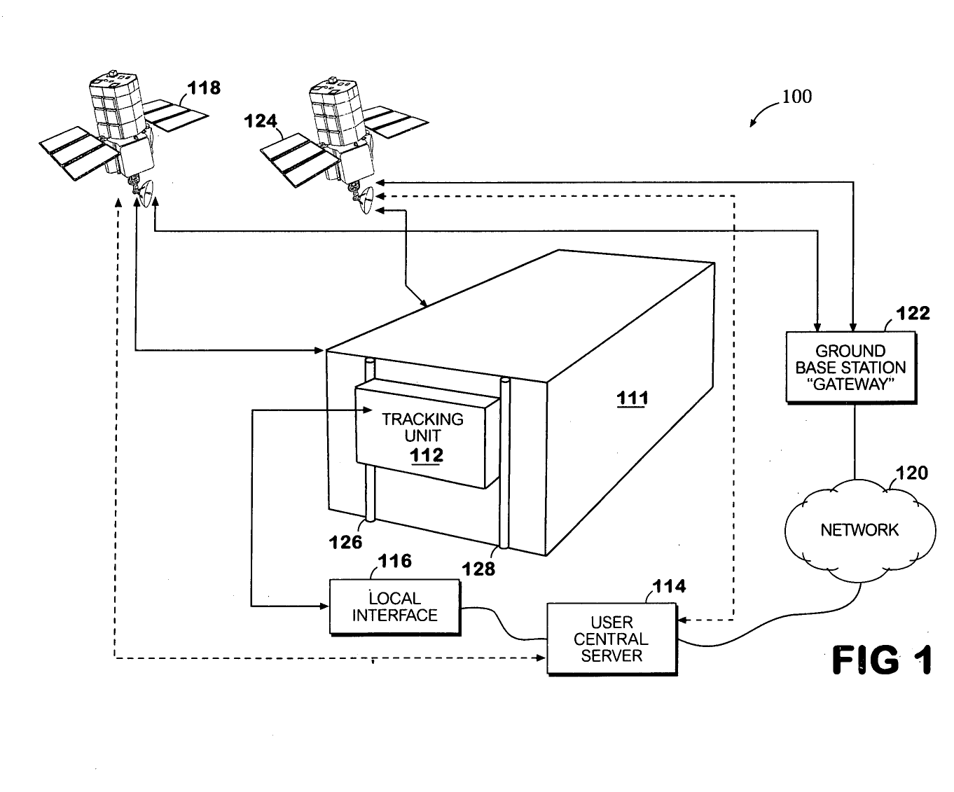

Referring now in more detail to the figures in which like reference numerals identify corresponding parts, FIG. 1 illustrates an example system 100 for tracking container 111. As indicated in this figure, the system 100 generally comprises at least one global positioning satellite 118, at least one two-way communication satellite 124, a tracking unit 112, a user central server 114, a ground base station (or “gateway”) 122, a network 120 and optionally a local interface 116. The two-way communication satellite 124 and ground base station 122 are components of the Orbcomm two-way satellite communication system (“Orbcomm System”) 130. As shown in FIG. 1, the user central server 114, for instance, comprises desktop personal computers (PCs, such as Macintosh computers). The server 114 is typically utilized in the transporting industry, such as the trucking, railroad, and shipping industry. The shipping container 111 is used to temporarily store or transport items and may be detachable to or permanently connected to a transporting machine such as a vehicle, train or ship.

In the embodiment shown in FIG. 1, the tracking unit 112 is portable in that the unit 112 moves along the surface of the earth in that the unit 112 may be removed from one container and connected to another. The tracking unit 112 is also self-contained because the unit 112 can operate independently and separately on its own, powered by a power supply and controlled by a processing device. As shown in FIG. 1, the unit 112 is connected to the container 111 for moving by a truck, train, or ship. The tracking unit 112 may be connected anywhere on the container 111. However, it is preferably connected to the outside of the container 111 and preferably coupled to locking bars 126, 128 of the container 111, as further described below.

The tracking unit 112 can locate its position along the surface of the earth and communicates its location to the user central server 114 via the two-way communication satellite 124 and the GPS satellites 118. The unit 112 receives signals from at least three (3) GPS satellites 118 from which it determines its location on the earth's surface. In addition, the tracking unit 112 can communicate with the user central server 114 via the Orbcomm system 130 and network 120. The Orbcomm two-way communication satellite 124 receives data from the tracking unit 112 and relays the data to the Orbcomm ground base station 122, which in turn relays the tracking information to the user central server 114 via a network 120. In the alternative, or in addition, the satellite 124 may communicate directly to the user central server 114 bypassing the ground base station 122 and network 120. In both alternatives, the user central server 1 14 receives the tracking information so that it can track the container 111 as it travels to its destination.

In both alternatives mentioned above, the tracking unit 112 may also communicate to the user central server 114 whether the container 111 and the unit 112 was tampered with, whether the unit 112 was off-course, and whether the unit 112 was detached from the container 111, and maintenance and server information for the tracking unit 112.

It should be understood that the GPS function and two-way communication function can be incorporated in one satellite or in two satellites with one function in each.

A local interface device 116 can be provided for local intermittent communication between the tracking unit 112 and the user central server 114. The local interface device 116 can communicate to both the tracking unit 112 and central server 114 by way of either wire or wireless connection or both. The local interface device 116 can gather diagnostic information regarding the tracking unit 112. The diagnostic data provides the settings and parameters of the unit 112 such that a user may check whether the unit 112 is properly functioning as intended. The diagnostic data may include its tracking location data, identification data, GPS receiver check status, modem check status, power status, etc. It should be noted that the diagnostic data can be communicated via the Orbcomm system 130.

The local interface device 116 can be designed to associate the tracking unit 112 with the container 111 and communicate such information to the central server 114. In other words, each tracking unit 112 is assigned to a container. The local interface device 116 records the assignment of a tracking unit 112 to a container 111 and communicates the assignment to the central server 114.

The network 120, as shown in FIG. 1, can comprise one or more sub-networks that are communicatively coupled to each other. By way of example, these networks include one or more local area networks (LANs) and/or wide area networks (WANs).

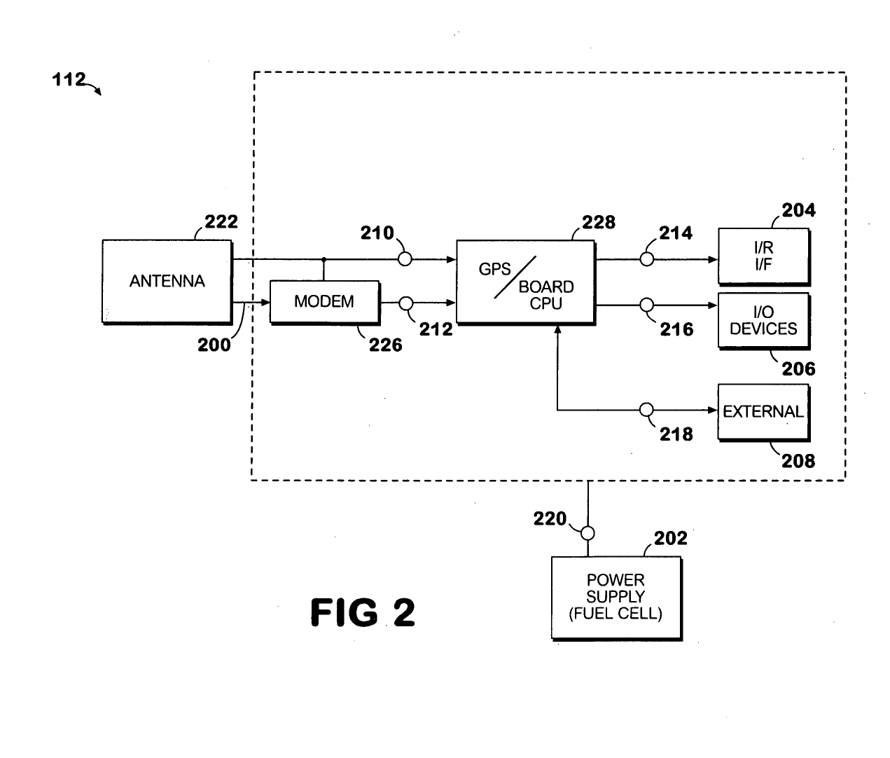

FIG. 2 is a schematic view of an embodiment of the tracking unit 112 and local interface 116 as shown in FIG. 1. As mentioned above, the tracking unit 112 communicates with the user central server 114 via the Orbcomm system 130 and network 120. In the alternative, or in addition, the tracking unit 112 can communicate directly to the central server 114 via satellite 124.

As shown in FIG. 2, an antenna system 222 is coupled to both a modem 226 and a Board CPU/GPS 228, as indicated by reference numerals 200 and 210, respectively. The antenna system on 222 is preferable designed to be operated in the very high frequency (VHF) band to receive and transmit data. During operation of the GPS, the antenna system 222 is preferably designed to operate at the GPS L-bands ranging from 950-2150 MHz. The antenna system may include more than one antenna. For example, a first antenna may operate to transmit and receive the VHF band and a second may operate at GPS L-Band.

The modem 226 is linked 212 to the Board CPU/GPS 228. The modem 226 can have an ASIC for data processing from the user central server 114. The modem 226 can process data from the Board CPU/GPS 228 and facilitate communication with the user central server 114. The modem 226 is preferably designed for an Orbcomm satellite system that includes a two-way satellite communication, i.e. Quake Global satellite modem. The modem 226 can transmit and receive signals in the VHF frequency range.

The input and output (I/O) devices 206 can include various mechanical and electrical sensors that monitor temperature, presence of certain chemicals, pressure, shock values, etc.; whether the container doors are locked; whether the tracking unit 112 is tampered with; and whether the tracking unit 112 is detached from the container 111.

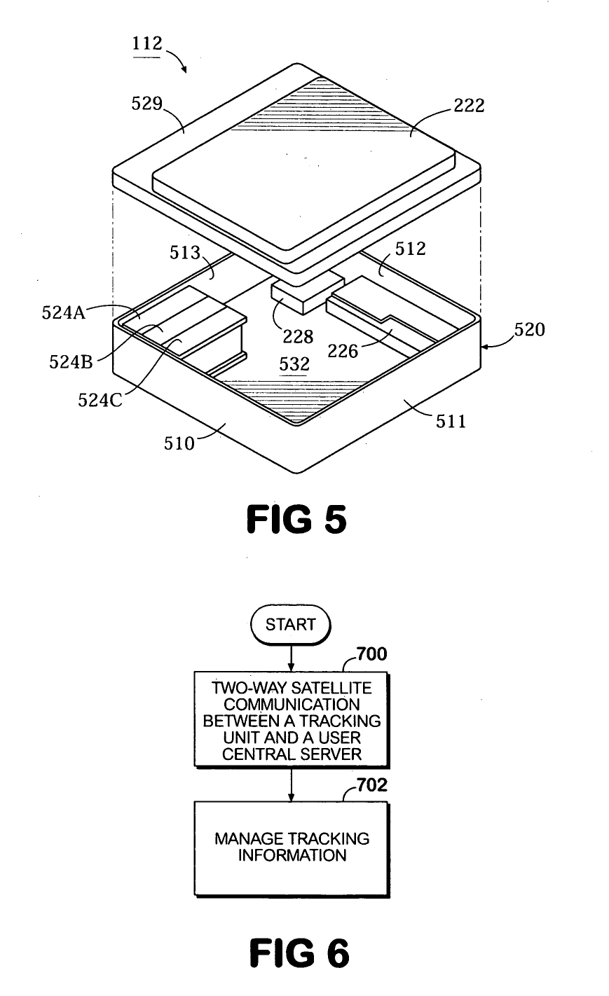

A self-contained power supply 202 can be included in the tracking unit 112 which is coupled to modem 226, Board CPU/GPS 228 and I/O devices 206. The power supply 202 may be fuel cells 524A-C (as shown in FIG. 5) and/or dry cells (not shown). The power supply 202 can include voltage and/or current regulator circuitry to supply power to the components in the tracking unit 112. The power supply 202 can also include detectors that detect the amount of voltage and/or current being drawn from the power source. In addition the power supply can include a power management and control circuitry for regulating the power consumption of the tracking unit 112. For example, the tracking unit 112 can operate in a sleep mode, during which the power management and control circuitry provides power to operate only the processing device on the Board CPU/GPS 228. The other components on the tracking unit 112 are switched off, thereby consuming less power.

The local interface device 116 can include an infrared interface (I/R I/F) 204 and external serial interface 208. The external serial interface 208 is coupled to the Board CPU/GPS 228, as indicated with reference numeral 218. The external serial interface 208 includes components used to facilitate connection of the Board CPU/GPS 228 to the local interface device 116 and therefore, for instance, comprise one or more serial, parallel, small system interface (SCSI), universal serial bus (USB), or IEEE 1394 (e.g., Firewire™) connection elements.

The infrared interface (I/R I/F) 204 is coupled to the Board CPU/GPS 228, as indicated by reference numeral 214. The I/R I/F 204 reads external data such as the container identification number. It should be noted that other types of communication, such as radio frequency, can be used for communication with the tracking unit 112 and local interface device 116.

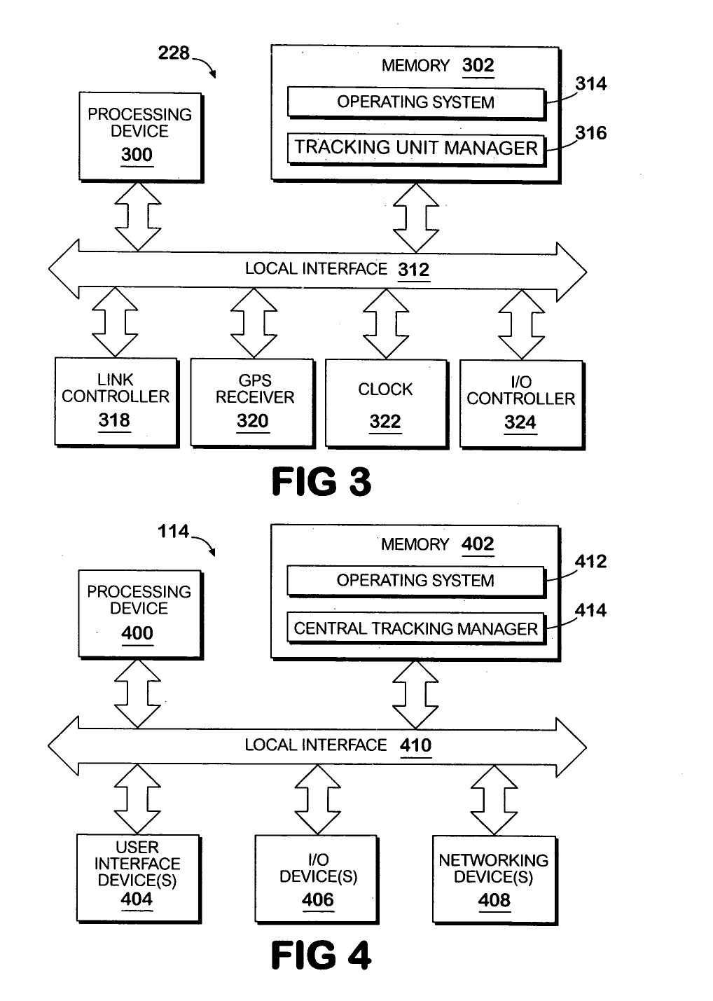

The Board CPU/GPS 228 manages the operation of the tracking unit 112. Board CPU/GPS 228 also includes a GPS receiver for locating the tracking unit 112 along the surface of the earth. The Board CPU/GPS 228 is further described in FIG. 3. FIG. 3 is a block diagram illustrating an example of the architecture for the Board CPU/GPS 228 as shown in FIG. 2. In the embodiment shown in FIG. 3, the Board CPU/GPS 228 comprises a processing device 300, memory 302, I/O controller 324, link controller 318, GPS receiver 320, and clock 322. The processing device 300 can include any custom made or commercially available processor, a central processing unit (CPU) or an auxiliary processor among several processors associated with the Board CPU/GPS 228, a semiconductor base microprocessor (in the form of a microchip) or a microprocessor. The memory 302 can include any one or a combination of volatile memory elements (e.g., random access memory (RAM, such as DRAM, SRAM, etc.)) and non-volatile memory elements (e.g., ROM, Hard Drive, Tape, CD-ROM, etc.).

The memory 302 normally comprises various programs, (in software and/or firmware) including an operating system (O/S) 314 and a tracking unit manager 316. The O/S 314 controls the execution of programs, including the tracking unit manager 316, and provides scheduling, input-output control, file and data management, memory management, and a communication control and related services. The tracking unit manager 316 facilitates the process for tracking the container 111 securing the tracking unit 112 and/or container 111, and maintaining and servicing the tracking unit 112. The tracking unit manger 316 may include a process that manages the power consumption of the tracking unit 112. For example, when operating in sleep mode, the tracking unit 316 manager enables the processing device 300 to operate at low power consumption while the other components of the unit 112 are switched off.

As shown in FIG. 3, the I/O controller 324 facilitates control and operation of the I/O devices 206, as shown in FIG. 2. The link controller 318 facilitates the control and operation of the modem 226 (shown in FIG. 2), external serial interface 208 and a GPS receiver 320.

In the embodiment shown in FIG. 3, the GPS receiver 320 receives tracking data from the global positioning satellite 118 and the tracking data is processed by the processing device 300. The tracking unit 112 receives synchronized data from multiple GPS satellites 118. In other words, all of the GPS satellites 118 send a signal at the same time. The GPS receiver 320 receives the signals, calculates the time differences between three or more signals, and determines the distance of the satellites from the tracking unit. Using the calculated distances between the satellites and the tracking unit 112, the receiver 320 can calculate the position of the tracking unit 112 along the surface of the earth.

FIG. 4 is a block diagram illustrating an example of the architecture for the user central server 114 as shown in FIG. 1. As indicated in FIG. 4, the user central server 114 comprises a processing device 400, memory 402, one or more user interface devices 404, one or more I/O devices 406, and one or more networking devices 408, each of which is connected to a local interface 410. The processing device 400 can include any custom made or commercially available processor, a central processing unit (CPU) or an auxiliary processor among several processors associated with the central server 114, a semiconductor based microprocessor (in the form of a microchip), or a macroprocessor. The memory 402 can include any one or a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 404 comprise those components with which the user (e.g., administrator) can interact with the central server 114. Where the central server 114 comprises a server computer or similar device, these components can comprise those typically used in conjunction with a PC such as a keyboard and mouse.

The one or more I/O devices 406 comprise components used to facilitate connection of the central computing device to other devices and therefore, for instance, comprise one or more serial, parallel, small system interface (SCSI), universal serial bus (USB), or IEEE 1394 (e.g., Firewire™) connection elements. The networking devices 408 comprise the various components used to transmit and/or receive data over the network 120, where provided. By way of example, the networking devices 408 include a device that can communicate both inputs and outputs, for instance, a modulator/demodulator (e.g., modem), a radio frequency (RF) or infrared (IR) transceiver, a telephonic interface, a bridge, a router, as well as a network card, etc. The memory 402 normally comprises various programs (in software and/or firmware) including an operating system (O/S) 412 and a central tracking unit manager 414. The O/S 412 controls the execution of programs, including the central tracking unit manager 414, and provides scheduling, input-output control, file and data management, memory management, and communication control and related services. The central tracking manager 414 facilitates the process for managing the tracking unit 112 and container 111. Typically, the process involves receiving data corresponding to managing the tracking unit 112 and container 111 via the Orbcomm system 130 and the network 120 and tracking the container 111 in accordance with the received data. In the alternative, or in addition, the process involves receiving the managing data directly from the two-way communication satellite 124.

FIG. 5 is a perspective view of an embodiment of the portable detachable self-contained tracking unit 112 as shown in FIG. 1. As indicated in FIG. 5, the tracking unit 112 is comprised of a housing 520, a housing cover 529, an antenna 222, a Board CPU/GPS 228, a modem 226, and fuel cells 524A-C. The fuel cells 524A-C, antenna 222, the Board CPU/GPS 228, and modem 226 are contained in the housing 520. The antenna 222 may be coupled to the housing cover 529, either along the interior wall of the housing cover 529 or integrated into or part of the housing cover 529. As mentioned above with reference to FIG. 1, the tracking unit 112 is designed to be portable in that the unit 112 moves along the surface of the earth and is detachable in that the unit 112 may be removed from one container 111 and connected to another. The tracking unit 112 is also self-contained because the unit 112 can operate independently and separately on its own, powered by its own power supply and controlled by its own processor.

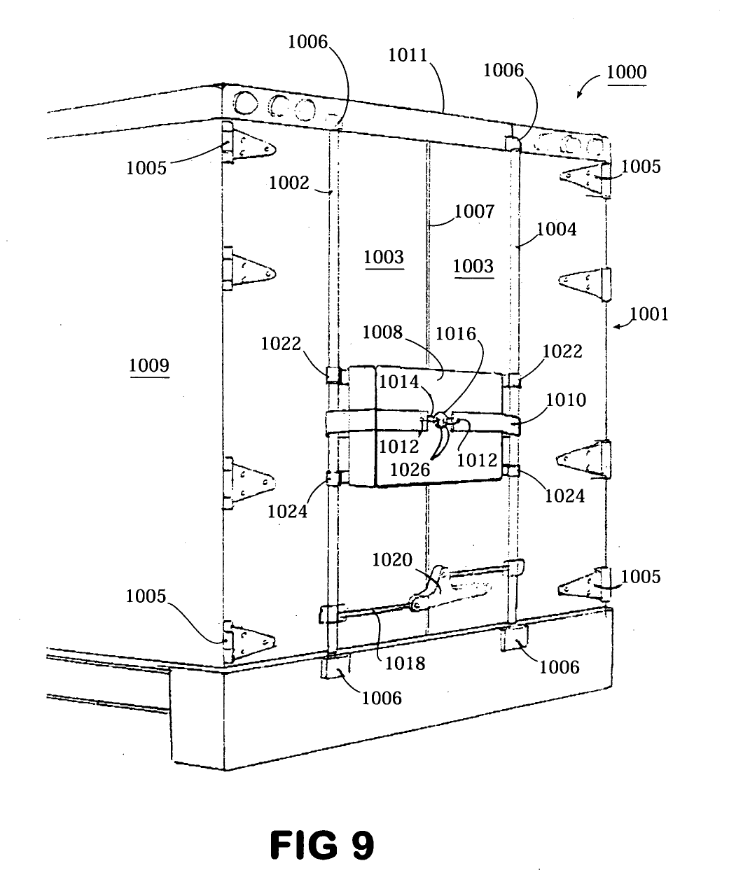

In the embodiment of FIG. 5, the housing 520 may be comprised of at least three side walls, preferably four side walls 510, 511, 512, 513 and a bottom wall 532. The housing 520 may be constructed to form a shape of a triangle, square or rectangle. The housing 520 may further include a housing cover 529 for covering the opening of the housing 520. The housing 520 may be sealed with an industry standard adhesive, and is preferably air-tight and waterproof. The housing 520 may be made of plastic and/or metal. The housing 520 protects the integrated components of the tracking unit 112 against any environmental strains and mechanical impacts. The interior of the housing may include three separate chambers: 1) fuel cells chamber, 2) Board CPU/GPS chamber and 3) modem chamber. The chambers may include raised walls such that the fuel cells 524A-C, Board CPU/GPS 228, and modem 226 may snugly fit into the chambers. FIG. 9 further illustrates an embodiment of the tracking unit 112 attached to the container door 111.

FIG. 6 illustrates a high-level example of the operation of the tracking system 100 for tracking a container 111 along the surface of the earth and determining the security of the container 111 and the tracking unit 112. With the system 100, a user can monitor the location of a container 111 by uploading the tracking information into the user central server 114. A user may also be notified whether the container 111 and tracking unit 112 have been tampered with, and whether the tracking unit 112 is detached from the container 111.

Beginning with block 700, the tracking system 100 communicates tracking data between the tracking unit 112 and the user central server 114 via two-way communication satellite 124. The tracking data may, for example, include the location of the tracking unit 112 and container 111; whether the container 111 and tracking unit 112 has been tampered with; and whether the tracking unit 112 is detached from the container 111. In addition, the data may include information of whether the container 111 is off-course during its travel to its destination (also known as geo fencing). The data may also include a container identification number for identifying the tracking unit 112 attached to the container 111. The information may further include of the settings and parameters to service and maintain the tracking unit 111. In short, the data allows the central server 114 to communicate, locate, manage, service, maintain, and monitor the security of the tracking unit 112. The information allows the central server 114 to monitor the security of the container 111.

In block 702, the system 100 manages the tracking information regarding the location of the tracking unit 112 and container 111 and security of the tracking unit 112 and container 111 and maintenance and service of the tracking unit 112. The system 100 can notify the user central server 114 when the tracking unit 112 is detached from the container 111, or when the container is off-course to its destination; when the tracking unit 112 has reached its destination; and when the tracking unit 112 or container unit 121 has been tampered with.

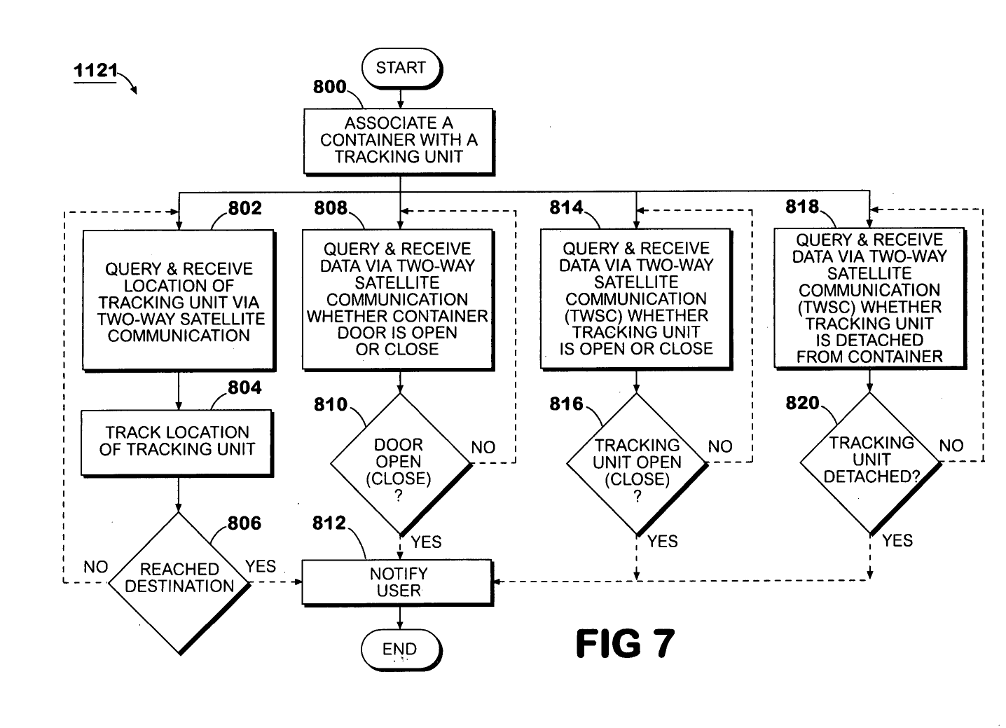

FIG. 7 illustrates an example of operation 1121 of the user central server 114 that facilitates tracking the container 111 and tracking unit 112 and the security of the container 111 and tracking unit 112. In block 800, the user central server 114 associates a container 111 with a tracking unit 112 via local interface device 116 or two-way communication satellite (TWCS) 124. For example, as mentioned with reference to FIG. 1, the local interface device 116 can detect an identification (ID) data on the container 111 and detect the identification ID data of the tracking unit 112.

The local interface device 116 transmits the container and unit ID data to the central server 114. The central server 114 links the container 111 and the tracking unit 112 together in the server's database. In the alternative, or in addition, the tracking unit 112 may detect the ID data on the container 111 and relay the container ID along with the tracker unit ID via TWCS 124 to the user central server 114. The server 114 then enters the information into its database associating the container 111 with the tracking unit 112.

In block 802, the user central server 114 can query the tracking unit 112 for the unit's location and receive the location data from the tracking unit 112, both via TWCS 124. For example, the user central server 114 can query the tracking unit 112 first and then receive location data from the tracking unit 112, or the central server 114 simply receives the location data from the tracking unit 112 without querying.

In block 804, the user central server 114 tracks the location of the tracking unit 112 by monitoring the unit's location. In block 806, the user central server 114 determines whether the tracking unit 112 has reached its destination or not. If the user central server 114 receives a signal that the tracking unit 112 did not reach its destination, then user central server 114 can continue to query and receive location data from the tracking unit 112, as shown in block 802. If the user central server 114 receives a signal that the tracking unit 112 did reach its destination, then the user central server 114 may notify the user that the tracking unit 112 and the container 111 have reached their destination, as shown in 812.

In the alternative, or in addition, as shown in block 808, the user central server 114 can also query and receive tampering data from the tracking unit 112 via TWCS 124 as to whether the container 111 or tracking unit 112 were tampered with. In block 810, the user central server 114 determines whether tampering has occurred or not. If the user central server 114 receives a signal that tampering did not occur, then the user central server 114 continues to query and receive the tampering data from the tracking unit 112. If the user central server 114 receives a signal that tampering did occur, then the user central server 114 may notify a user that the container 111 and tracking unit 112, or both, were tampered with, as shown in block 812.

In the alternative, or in addition, as shown in block 814, the user central server 114 can also query and receive off-course data from the tracking unit 112 via TWCS 124 of whether the container 111 and unit 112 are or were off-course or not. In block 816, the user central server 114 determines whether the tracking unit 112 and container 111 are or were off-course or not. If the server 114 receives a signal that the tracking unit 112 and or container 111 were not off-course, the user central server 114 continues to receive the off-course data from the tracking unit 112, and query tracking unit 112 to report the off-course data, both via TWCS 124. If the user central server 114 receives a signal that the tracking unit 112 and container 111 are or were off-course, then the user central server 114 may notify the user that the tracking unit 112 and the container 111 are or were off-course, as shown in 812.

In the alternative, or in addition, as shown in block 818, the user central server 114 can also query and/or receive detaching data from the tracking unit 112 via TWCS as to 124 whether the tracking unit 112 was detached from the container 111 or not. In block 820, the user central server 114 determines whether detaching occurred or not. If the user central server 114 receives a signal that detaching did not occur, then the user central server 114 continues to query and/or receive the detaching data from the tracking unit 112. If the user central server 114 receives a signal that detaching did occur, then the user central server 114 may notify the user that the tracking unit 112 was detached, as shown in block 812.

A sensor can be provided to determine whether the tracking unit 112 has been detached from the container 111 or not. For example, a spring could project from the back of the tracking unit 112 to the container 111. If the tracker unit 112 is detached, the spring would extend to create an electric contact in the unit signaling the unit's detachment, which would be communicated to the user central server 114.

In a similar fashion, tamper sensors could be place in the tracker unit 112 that would trigger a signal that the unit was being tampered with.

During the reception of data for the events mentioned above, the user central server 114 can also receive data as to the maintenance and service of the tracking unit 112. Based on this data, the user central server 114 can manage the tracking unit 112, such as power management, or notify the user that maintenance is needed or the batteries need to be replaced or serviced.

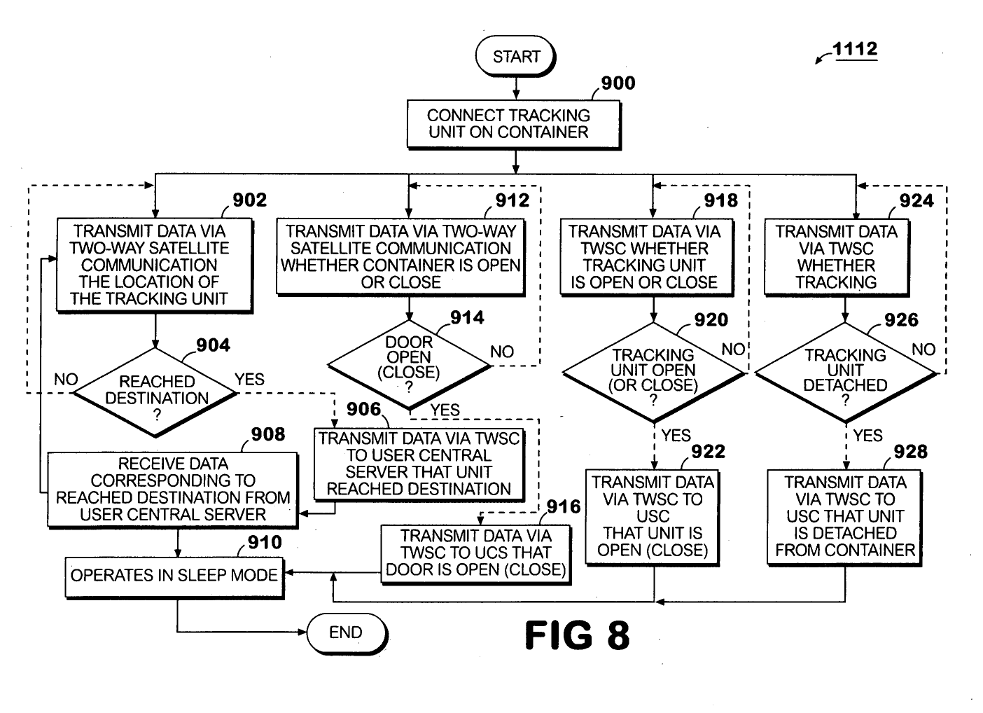

FIG. 8 provides an example of operation 1112 of the tracking unit 112 as shown in FIG. 1. Beginning with block 900 of FIG. 8, the tracking unit 112 is connected to the container 111, preferably on a door or doors 1003 of the container as shown in FIG. 9. More specifically, the tracking unit 112 may be placed between the locking bars 1002, 1004 (shown in FIG. 9) such that it may monitor whether the container door or doors 1003 were tampered with or not. The tracking unit 112 transmits its ID data to the user central server 114 via the local interface device 116 or TWCS 124. For example, as mentioned with reference to FIG. 7, the local interface device 116 can detect an identification (ID) data on the container 111 and detect the identification ID data of the tracking unit 112. The local interface device 116 then transmits container and unit ID data to the user central server 114. The user central server 114 links the container 111 and the tracking unit 112 together into the server's database. In the alternative, or in addition, the tracking unit 112 may detect the ID data on the container 111 and relay the container ID along with the unit ID via TWCS 124 to the user central server 114. The user central server 114 then enters the information into its database associating the container 111 with the tracking unit 112.

In block 902, the tracking unit 112 transmits location data to the user central server 114 for locating the tracking unit 112 and container 111. The tracking unit 112 can receive a querying signal via TWCS 124 from user central server 114 to report its location. In block 904, the tracking unit 112 determines whether the unit 112 has reached its destination or not. Optionally, the tracking unit 112 may also determine whether it has traveled off-course (i.e., geo-fencing). In this regard, the user central server 114 or the local interface device 116 may preprogram in the tracking unit 112 the location of its destination and the parameters of the traveling route to its destination. Therefore, the tracking unit 112 can calculate whether it reached its destination or traveled off-course.

If the container 111 and the tracking unit 112 have not reached their destination or have traveled off-course, then the tracking unit 112 continues to transmit the destination data or off-course data to the user central server 114 and receive query signals from the user central server 114 to report destination data and off-course data as indicated in block 902. If the container 111 and tracking unit 112 have reached their destination or traveled off-course, the tracking unit 112 transmits data via TWCS 124 to user central server 114 that the tracking unit 112 and container 111 have reached their destination or traveled off-course, as shown in block 908. After the tracking unit 112 has transmitted to user central server 114 that it has reached its destination or traveled off-course, the tracking unit 112 may optionally operate in sleep mode, as shown in block 910.

In the alternative, or in addition, as shown in block 912 and 918, the tracking unit 112 may transmit tampering data to user central server 114 via TWCS 124, which indicates whether the container 111 or tracking unit 112 was tampered with or not. The tracking unit 112 may receive a query signal via TWCS 124 from user central server 114 to report tampering data. In block 914 and 920, the tracking unit 112 determines whether tampering occurred with the door or any other part of the container or tracking unit 112 where tampering sensors are located. If there was no tampering, then the tracking unit 112 continues to transmit via TWCS 124 to the user central server 114 that the container 111 and tracking unit 112 were not tampered with, and to receive query signals from the central server 114 to report tampering data. If there was tampering, then the tracking unit 112 transmits via TWCS 124 to user central server 114 that the tracking unit 112 and container 111 were tampered with, as shown in 916 and 922. Then as shown in block 910, the tracking unit 112 may optionally operate in the sleep mode.

In the alternative, or in addition, as shown in block 924, the tracking unit 112 may transmit via TWCS 124 to the user central server 114 detaching data, indicating whether the tracking unit 112 was detached from the container 111. The tracking unit 112 may optionally receive a query signal via TWCS from user central server 114 to report detaching data. In block 926, the tracking unit 112 determines whether it was detached from the container 111 or not. If detaching did not occur, the tracking unit 112 continues to transmit to the user central server 114 that it was not detached and receive query signals from the user central server 114 to report detaching data. If detaching did occur, then the tracking unit 112 may transmit to user central server 114 that it was detached from the container 111, as shown in block 928. After the tracking unit 112 transmits to user central server 114 that it was detached from the container 111 or was not detached, the tracking unit 112 may optionally operate in the sleep mode, as shown in block 910.

During the transmitting of data for the events mentioned above, the tracking unit 112 may also transmit data about the maintenance and service of the tracking unit 112, such as power management and battery condition, GPS receiver check status, and modem check status.

FIG. 9 represents one means of securing the tracking unit 1008 to a sea going container or the trailer of a tractor-trailer rig 1000. The container or trailer 1000 has an opening end 1001 and two doors 1003 with conventional hinges 1005 attached to the container or trailer for closing the opening end 1001.

A crack 1007 is shown where the doors 1003 meet when they are closed. The tracking unit 1008, which contains all of the electronic components, is attached to the container or trailer 1000. The tracking unit 1008 secures the two doors 1003 in the closed position by a locking belt 1010 which is securely attached to the back end of the tracking unit 1008 by fastening means such as being bolted to the back of tracking unit 1008 (not shown). The locking belt 1010 may have two apertures 1012 near each end of the belt that meet near the center of the tracking unit 1008 on its front side. A locking wire 1014 can be treaded through those two apertures 1012 with the two ends being secured together by security seal 1016. The locking belt 1010 extends around the left trailer locking rod 1002 and the right trailer tracking rod 1004.

The opening ends 1001 of container or trailer 1000 are usually similar in design. The doors 1003 are attached to the container or trailer 1000 by conventional hinges 1005 at the top and bottom of the container or trailer near each side 1009. Locking hatches 1006 secure the locking rods 1002 and 1004 to the top and bottom of the trailer and may be attached by a rod (not shown) to the trailer locking bar 1018. A trailer-locking handle 1020 is attached to this bar 1018 for unlatching the locking rods 1002 and 1004 from locking latches 1006. This trailer-locking handle 1020 is usually secured by locking through one of the doors 1003 so that the doors 1003 can not be opened without unlocking.

The tracking unit 1008 may be placed between the left locking rod 1002 and right locking rod 1004 or may be placed outside of the locking rods 1002 and 1004. If there was sufficient room between the locking rod 1002 or 1004 and the side 1009, the tracking unit 1008 could be placed there.

It is preferable that the tracking unit 1008 has means for securely fixing the unit at the desired vertical location along locking rods 1002 and 1004. There are many means by which this can be accomplished. One means is shown in FIG. 9 which has upper positioning clamps 1022 and lower positioning clamps 1024. These clamps can be secured to the locking rods 1002 and 1004 in a number of ways. One simple means is to have tightening screws for tightening the positioning clamps 1022 and 1024 around the locking rods 1002 and 1004. The locking belt 1010 can be made out of any suitable material such as leather, webbing or metal. This security seal 1016 may be a custom stamp. The security seal could be a lead ball in which each end of the locking wire is securely fastened so that the locking wire 1014 can not be removed without damaging the seal. Many customs authorities have special tools to make such a seal. Having this type of seal is important as it may permit a container from one country to enter through the customs authority of another country without the necessity of breaking the seal. The seal applied by the customs authority is proof that the paperwork on the shipment and the contents on the inside have been approved and accepted by the customs authority on a shipment going from one country to another. This seal could be broken by the customs authority at the entry point into the other country if it is necessary to inspect the contents of the container. If the customs authority breaks the seal, it may reseal it as it continues its journey into the country of its destination. One advantage of having this as an official custom seal, which can only be applied by a special tool possessed by the customs authority, is that some customs authorities will allow the container to enter a country from a foreign country and proceed to its destination where the seal may be broken. The security seal 1016 can be made of lead or nylon.

The locking wire 1014 can be a wire or a nylon strap. Basically this locking system, using a locking wire 1014 and security seal 1016, is designed so that the container or trailer 1000 cannot be opened without breaking the security seal 1016 or the locking wire 1014 which would obviously alert the customs authority or the party to whom the container 1000 is shipped that the container may have been opened and its contents tampered with or removed or other contents added to the container or trailer. This security feature is important to fulfill the requirements imposed by insurance carriers.

The locking wire 1014 could also be a commercially available plastic strap which extends through a plastic lock which is an integral part of the plastic strap which cannot be opened without cutting the plastic strap. A bar code or other similar identification mark could be placed on the locking wire 1014 to ensure that the locking wire 1014 and security seal 1016 have not been removed and replaced with the locking wire and security seal that appears to be identical.

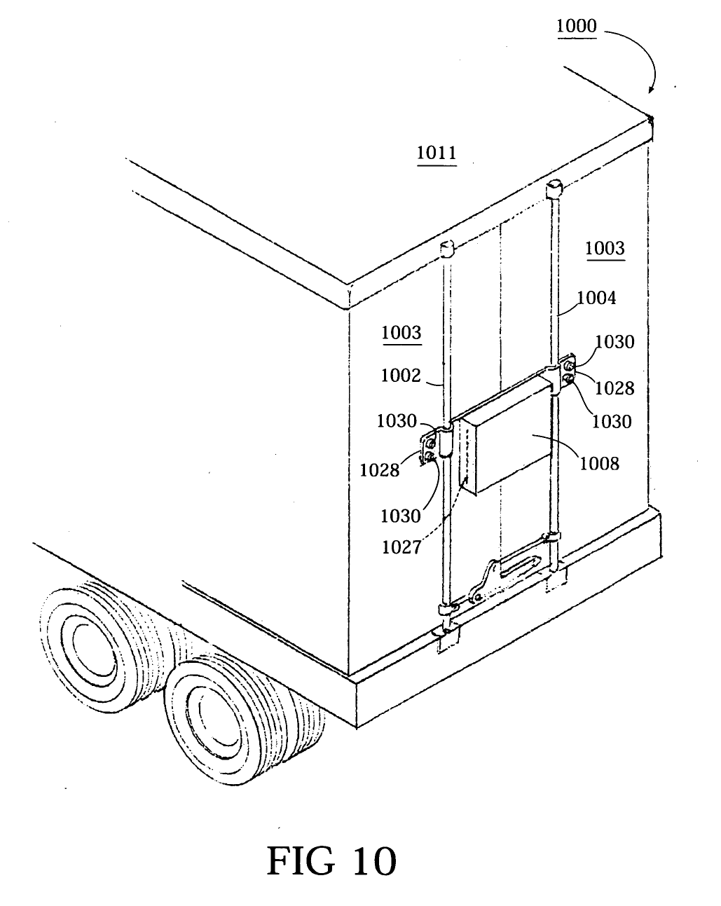

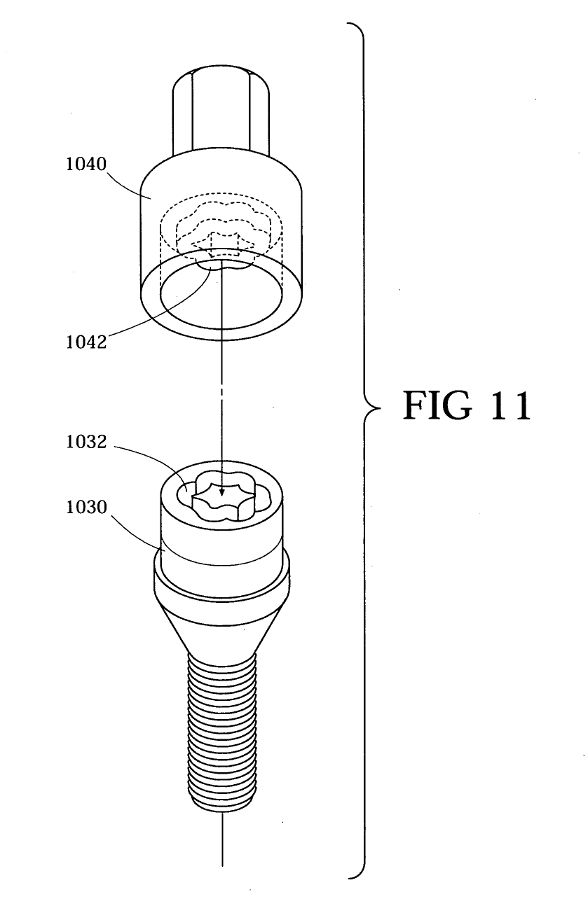

FIG. 10 is another embodiment of the locking system for locking the tracking unit 1008 to the container 1000. The description of the trailer or container set forth above in respect to FIG. 9 is equally applicable to FIG. 10. The tracking unit 1008 is mounted to the opening end of the trailer or container 1000. The tracking unit 1008 shows the antenna 1027 in a vertical position in reference to the top of the container 1011, which is preferable for communication. If there is sufficient space between the locking rods 1002 and 1004 on the doors of the container 1003, the tracking unit 1008 can be mounted in that position. In many cases there is not sufficient space so the tracking unit 1008 must be mounted outside of locking rods 1002 and 1004. The tracking unit 1008 is securely mounted by fastening brackets 1028, which are curved to fit over the outside of locking rods 1002 and 1004. In order to provide additional security the fastening brackets 1028 can be made as an integral part of the tracking unit 1008. Alternatively the fastening brackets 1028 can be attached through the back of tracking unit 1008 by bolts or other means with the back of the tracking unit 1008 being so close to the surface of the doors 1003 that the bolts cannot be removed without also removing the fastening brackets 1028. In other words the curvature of the brackets 1028 around locking rods 1002 and 1004 is designed such that the tracking unit 1008 fits flush against the container doors 1003. The fastening brackets 1028 can be fastened to the doors 1003 of the trailer by special studs 1030 that screw in to corresponding female openings in the doors 1003. Because the distance between the corresponding holes in the trailer doors 1003 may vary the fastening brackets may have a slot or other means to fit doors where there is a difference in the distance between the female openings on the right and the left doors 1003. A simple slot could be provided in bracket 1028 through which the special stud is screwed. A special stud 1030 can be provided with special features to deter unauthorized removal. An example of this is illustrated in FIG. 11 which shows the special stud 1030 which is a designed like one of the studs on each wheel of some European automobiles to deter the unauthorized removal of the wheel. A special socket 1040 for use with a socket handle is illustrated in FIG. 11. The special stud 1030 has a female opening 1032 of a special configuration while the socket 1040 has a male end 1042 that fits snuggly inside of the female opening 1032 of the special stud 1030 so it can be removed. To provide additional security, the stud 1030 for each hole in the fastening bracket 1028 could have a different configuration, which would require a different socket 1040 with a different configured male end 1042. Thus, four different sockets would be required to remove the fastening bracket 1028.

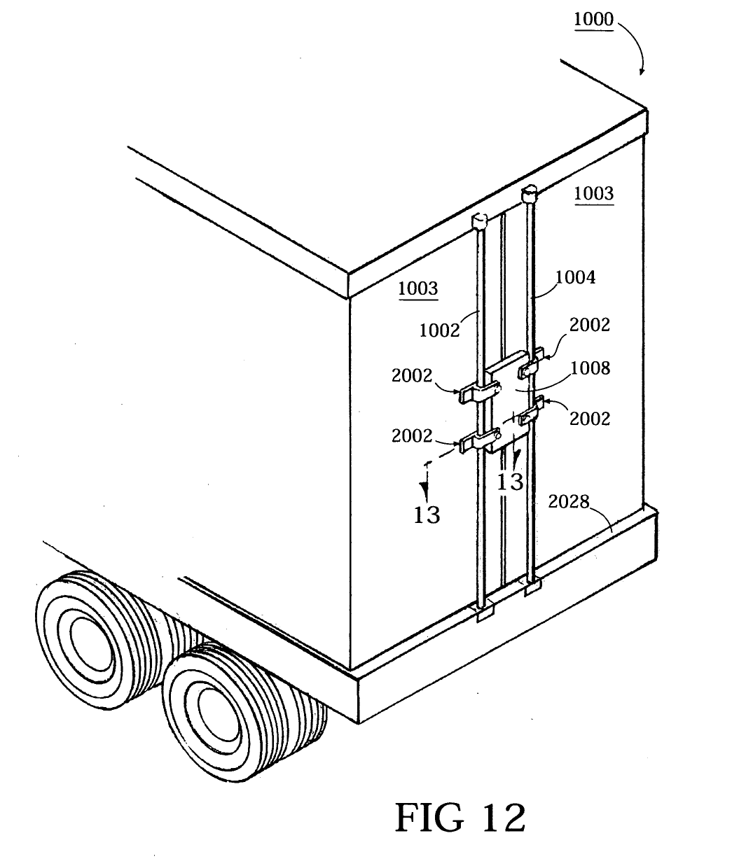

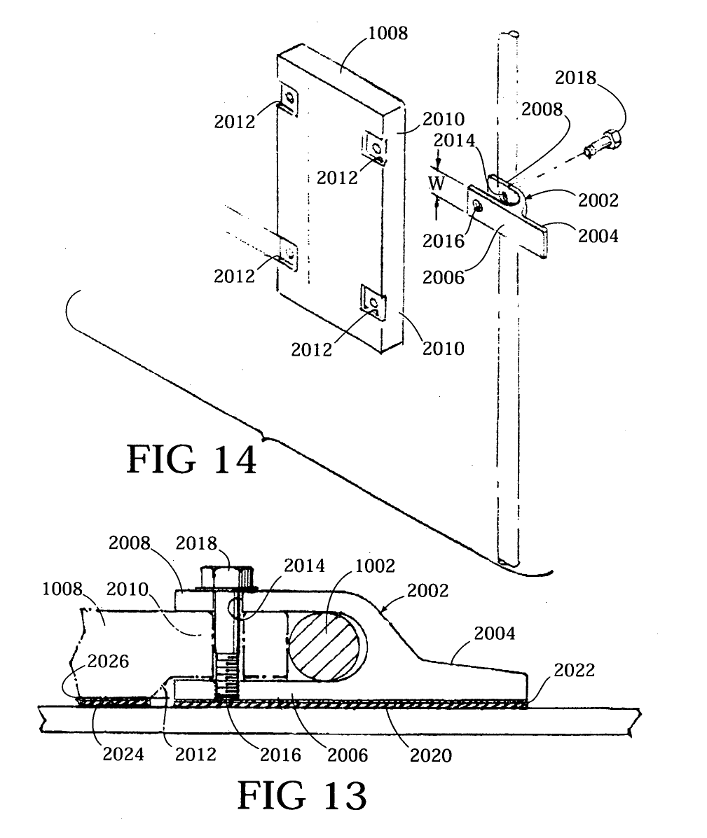

FIG. 12 shows an alternative way of mounting the tracking unit 1008. In this case the left locking rod 1002 and right locking rod 1004 are spaced closer together than in the earlier described embodiments. In this case the tracking unit 1008 is located with its long dimension being in the vertical position in respect to the container or trailer 1000. The tracking unit 1008 fits between locking rods 1002 and 1004. The tracking unit 1008 is attached to locking rods 1002 and 1004 by a U shaped bracket 2002 with a tongue extension 2004 as shown in FIG. 13. The U shaped portion of the bracket 2002 extends around locking rod 1002 or 1004. The inner portion 2006 of the U shaped bracket 2002 is skewered to the outer portion 2008 of the U shaped bracket 2002. A portion 2010 of the tracking unit 1008 extends between the inner portion 2006 and outer portion 2008 of the U shaped bracket 2002. This portion 2010 of the tracking unit 1008 may have a recess 2012. The U shaped bracket 2002 is connected to the tracking unit 1008 as shown in FIG. 12. One way of securing the tracking unit 1008 to a locking rod 1002 or 1004 is by providing an aperture 2014 that extends through the outer portion 2008 of the U shaped bracket 2002 and through the tracking unit 1008. A threaded bore 2016 is provided in the inner portion 2006 for receiving a threaded stud 2018. The threaded stud 2018 can be tightened to firmly attach the portion 2010 through the U shaped bracket 2002. It may also be constructed in such a manner as to apply pressure to the locking rod 1002 or 1004 to prevent the tracking unit 1008 from moving up and down on the locking rods 1002 and 1004. The other U shaped brackets 2002 are constructed in the same manner. A cushioning material 2020 may be placed between the U shaped bracket 2002 and the door 1003 of the trailer. This cushioning material 2022 may be adhered to the bottom of the U shaped bracket 2002 or to the door 1003 by an adhesive strip 2022. A cushioning material 2020 and adhesive strip 2022 may be placed between the back of the tracking unit 1008 and the door 1003. The U shaped bracket 2002 has an elongated tongue 2004 and a width W as illustrated in FIG. 14. The length and the width W of the U shaped bracket is made of a sufficient size to support the U shaped bracket 2002 in position. The U shaped bracket 2002 can be made out of any suitable material, such as steel. Certain types of strong plastics such as high density nylon can be utilized to reduce the shock that may be transmitted from the container 1000 to the tracking unit 1008. The cushioning material 2020 and 2024 may also help reduce the shock transmitted by the container 1000 to the tracking unit 1008. It may be important to reduce the transmission of shock to the tracking unit 1008 to avoid damage to the electronics contained therein.

It will be noted in FIG. 12 that the tracking unit 1008 is located a suitable distance above the floor 2028 of the container 1000 so as not to interfere with the loading and unloading of the container 1000.

It should also be pointed out that the threaded studs 2018 can have a female opening 1032 as illustrated in FIG. 11 by special stud 1030. A special socket 1040 will then be needed to unthread the threaded stud 2018. As pointed out above, each of the threaded studs 2018 may have a female opening 1032 of a different configuration requiring a different socket 1040 to remove each stud.

It should be pointed out that it may be possible to open the container 1000 by only removing the threaded studs 2018 on one side of the container 1000. Better security may be provided if it is necessary to open all four threaded studs 2018. The locking system illustrated in FIG. 12 is not limited to the requirement of having four U shaped brackets 2002. Two or even more than four brackets may be required under certain circumstances.

An additional advantage of having the length and width W of the U shaped bracket 2002 of a sufficient size and to have the cushion 2020 and 2024 is to prevent damage to the surface of the doors 2003 of the container 1000.

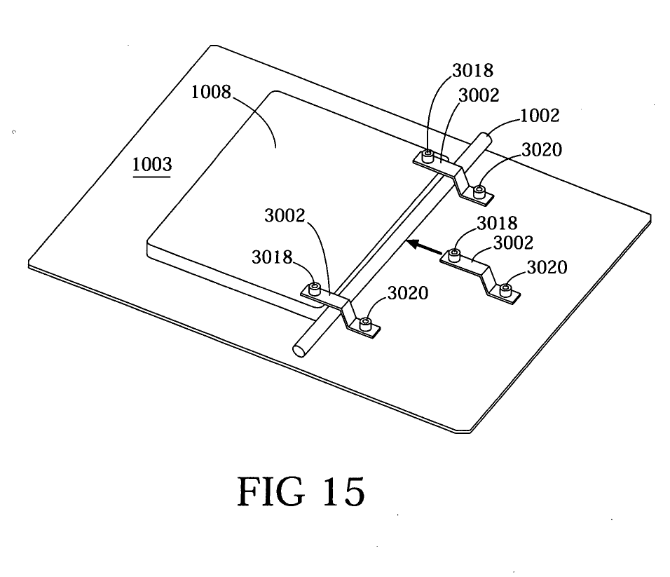

As illustrated in FIG. 15 the tracking unit 1008 can be attached to the container door 1003 by one or more clamps 3002 with clamp to a single locking rod 1002. The clamp has a stud 3018 that screws in to the tracking unit 1008 and on into threads in the container door 1003. A stud 3020 attaches the clamp directly to the door. The clamp 3002 clamps directly to the door 1003. The studs 3018 and 3020 may be special studs. Stud 1030 described in FIG. 11 may lock metal covering plate (not shown) can be placed over the studs 3018 and 3020 to prevent their removal. The studs 3018 are screwed tight enough to prevent the locking rod 1002 from being moved up to open the door 1003.

It should also be pointed out that the sensor can be placed in the tracking unit 1008 to record whether it has been

The tracking unit 112 can be built into the shipping container 111 as a part of the door. The tracking unit 112 can provide the same information as described above. This built in tracking unit 112 (not shown) can have a sensor for determining when the door of the shipping container is open which can then be communicated to the user central server 114 via the two-way satellite. Tamper sensors can also be placed in the tracking unit 112 and this information conveyed to the user central server 114. In the event the tracking unit 112 is built into the door of the shipping container 111, provision can be made for the easy replacement of the battery or other power source.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included here in within the scope of this disclosure and the present invention and protected by the following claims.

1. A system for tracking the location of a shipping container via communication with a satellite and a central server comprising:
a central server;
a portable detachable tracking unit comprising:
an antenna that is capable of communication with both a GPS satellite and a two-way satellite;
a processing device;
a GPS receiver for receiving signals from the GPS satellite;
a transmitter for transmitting information to the central server via the two-way satellite;
a modem;
a housing; and
means for attaching and detaching the tracking unit to the shipping container.

2. The system of claim 1, in which the tracking unit has detecting means for detecting when it has been detached from a shipping container and communicating that information via the two-way satellite to the central server.

3. The system of claim 1, in which the tracking unit has detecting means for detecting when it has been tampered with and communicating that information via the two-way satellite to the central server.

4. The system of claim 1, in which the tracking unit also has a receiver for receiving communications from the two-way satellite.

5. The system of claim 1, in which the tracking unit further includes an internal power supply.

6. The system of claim 5, in which the internal power supply of the tracking unit is provided by one of a fuel cell and battery.

7. The system of claim 1, in which the tracking unit has a memory capable of receiving and storing geo-fencing information on the specified route to its destination and the processing device is programmed to determine if the tracking unit is outside of the geo-fence and to communicate that information to the central server via the two-way satellite.

8. The system of claim 1, in which the shipping container has at least one door and at least one locking bar for locking all doors with the tracking unit being attached to the locking bars so that the locking bars can not be unlocked without first detaching the tracking unit.

9. The system of claim 1, in which the shipping container has at least one door and at least one locking bar for locking all doors with the tracking unit being attached to the locking bars by least one clamp that clamps around a locking bar that prevents the tracking unit from moving up and down on the bar and the tracking unit is also directly attached to the shipping container so that the bars can not be moved to unlock the doors without detaching the tracking unit.

10. The system of claim 8, in which the tracking unit is attached to at least one locking bar by a special fastener that can not be released without using a special tool.

11. The system of claim 1, in which the antenna in the tracking unit is located in the vertical position in relation to the surface of the earth in order to better transmit and receive communications.

12. A portable detachable tracking unit for transmitting its location via communication with a satellite to a central server, said tracking unit being capable of being attached and detached from a shipping container, said tracking unit comprising:
an antenna that is capable of communication with both a GPS satellite and a two-way satellite;
a processing device;
a GPS receiver for receiving signals from the GPS satellite;
a transmitter for transmitting information to the central server via the two-way satellite;
a modem;
a housing; and
means for attaching and detaching the tracking unit to a shipping container.

13. The portable detachable tracking unit of claim 12, which has detecting means for detecting when it has been detached from a shipping container and communicating that information via the two-way satellite to a central server.

14. The portable detachable tracking unit of claim 12, which has detecting means for detecting when it has been tampered with and communicating that information via the two-way satellite to a central server.

15. The portable detachable tracking unit of claim 12, in which the tracking unit also has a receiver for receiving communications from a two-way satellite.

16. The portable detachable tracking unit of claim 12, in which the tracking unit has an internal power supply.

17. The portable detachable tracking unit of claim 16, in which the internal power supply of the tracking unit is provided by one of a fuel cell and battery.

18. The portable detachable tracking unit of claim 12, in which the tracking unit has a memory capable of receiving and storing geo-fencing information on the specified route to its destination and the processing device is programmed to determine if the tracking unit is outside of the geo-fence to and communicating that information to the central server via the two-way satellite.

19. The portable detachable tracking unit of claim 12, in which the antenna is located in the vertical position in relation to the surface of the earth in order to better transmit and receive communications.

20. The portable detachable tracking unit of claim 12, in which a cushioning material is placed between the back of the tracking unit and a door of the shipping container.

21. A shipping container with at least one door and at least one locking bar for locking all doors and a portable detachable tracking unit, said tracking unit comprising:
an antenna that is capable of communication with both a GPS satellite and a two-way satellite;
a processing device;
a GPS receiver for receiving signals from the GPS satellite;
a transmitter for transmitting information to a central server via the two-way satellite;
a modem;
a housing; and
means for attaching said tracking unit to the locking bars so that the locking bars can not be unlocked without first detaching the tracking unit.

22. A shipping container with at least one door with a built-in tracking unit for transmitting its location via communication with a satellite and a central server, said tracking unit comprising:
an antenna that is capable of communication with both a GPS satellite and a two-way satellite;
a processing device;
a GPS receiver for receiving signals from the GPS satellite;
a transmitter for transmitting information to a central server via the two-way satellite;
a modem; and
means for determining when a door of the shipping container is open and means for communicating that information via the two-way satellite to the central server.

23. The shipping container and built -in tracking unit of claim 21 in which there are also means for determining when the tracking unit has been tampered with and means for communicating that information via the two-way satellite to the central server.

24. The portable detachable tracking unit of claim 12, in which the tracking unit further includes a battery that powers those components which need to be on to receive messages from the central server via the two-way satellite and to power a clock and to turn other electrical components on that are powered by another source of power, and a fuel cell that powers all components not powered by the battery.

25. A method of monitoring a shipping container during shipping from a shipping point to a destination via a portable detachable tracking unit, at least one satellite and central server, comprising:
associating the shipping container with the portable tracking unit attached to the container in the central server;
the tracking unit determining whether certain events have occurred or not on one of the shipping container and the portable detachable tracking unit or both, the tracking unit transmitting that information to the central server via the satellite; the tracking unit periodically determining its location via GPS satellites and transmitting that information to the central server via the satellite;
determining whether the tracking unit is on course to its destination based upon this transmitted information according to a predetermined route or not; and
generating a message concerning whether the tracking unit is on course or not and whether the certain event has occurred or not.

26. The method of claim 25, in which the certain event is that the tracking unit has just went off course.

27. The method of claim 25, in which the certain event is that the tracking unit has been detached from the shipping container.

28. The method of claim 25, in which the certain event is that the tracking unit has been tampered with.

29. A portable detachable tracking unit for transmitting its location via communication with a satellite to a central server, said tracking unit being capable of being attached and detached from a shipping container, said tracking unit comprising:
an antenna that is capable of communication with both a GPS satellite and a two-way satellite;
electronic means for receiving communications from the GPS satellite;
electronic means for communicating with at least one two-way communication satellite;
said electronic components being placed by an internal power source; and
all of said components being housed in a housing that has means for attaching and detaching to a shipping container.

30. The portable detachable tracking unit of claim 29, which has means for showing the unauthorized detachment from a shipping container.

31. The portable detachable tracking unit of claim 29, which has means to shut down part of the electronic components and waking them up upon the occurrence of certain events or a command received from the central server.

32. The portable detachable tracking unit of claim 29, which has means to connect to a nearby computer with access to the tracking unit being programmed to only grant access pursuant to a secret code, said tracking unit being capable of being programmed by the nearby computer to carry out certain functions and to transmit certain information.

33. The portable detachable tracking unit of claim 29, in which a cushioning material is placed between the back of the tracking unit and a door of the shipping container.
